(19) United States
(12) Patent Application Publication
(10) Pub. No.: US 2015/0338811 A1
(43) Pub. Date: Nov. 26, 2015

(54) IMAGE FORMING APPARATUS

(71) Applicant: KYOCERA Document Solutions Inc., Osaka (JP)

(72) Inventor: Yoshimasa Okura, Osaka (JP)

(21) Appl. No.: 14/720,585

(22) Filed: May 22, 2015

(30) Foreign Application Priority Data
May 26, 2014 (JP) 2014-108051

(51) Int. Cl. G03G 15/00; G03G 21/12

(52) U.S. Cl. CPC G03G 15/55; G03G 21/12

(57) ABSTRACT

An image forming apparatus includes a container storage portion, a biasing member, a lid member, a detection sensor, and an abnormality determination processing portion. The container storage portion has an opening through which a waste toner collection container is inserted and pulled out, and stores the container at a storage position. The biasing member biases the container toward the opening. The lid member is moved between an opened attitude to open the opening and a closed attitude to close the opening. The detection sensor detects a predetermined detection object in the container at the storage position. The abnormality determination processing portion determines whether an abnormality has occurred based on an output signal of the detection sensor, the abnormality including a state where the container is full of the waste toner, and a state where the container is not stored in the container storage portion.

### INCORPORATION BY REFERENCE

This application is based upon and claims the benefit of priority from the corresponding Japanese Patent Application No. 2014-108051 filed on May 26, 2014, the entire contents of which are incorporated herein by reference.

### BACKGROUND

The present disclosure relates to an electrophotographic image forming apparatus for forming an image by using toner.

In an image forming apparatus, generally, an electrostatic latent image formed on an image carrier such as a photoconductor drum is visualized by a developing device by using developer (toner), and the toner image is transferred to a recording medium. During this process, toner that has not been transferred to the recording medium may remain on the surface of the photoconductor drum. As a result, the residual toner is removed from the surface of the photoconductor drum by a cleaning device. The residual toner removed from the surface of the photoconductor drum is conveyed as waste toner by a screw to an end portion in the horizontal direction, and dropped from the end portion into a waste toner collection container and stored therein.

The image forming apparatus includes a container storage portion for storing the waste toner collection container. A lid member for opening and closing the container storage portion is provided as a part of the exterior of the image forming apparatus. When the waste toner collection container is full of waste toner, the user opens the lid member to perform the replacement work of the waste toner collection container.

In the above-described configuration, a full detection sensor for detecting whether or not the waste toner collection container is full of waste toner is provided in order to prevent the waste toner from overflowing from the waste toner collection container. In addition, a door sensor for detecting whether or not the lid member is closed is provided in order to avoid some problems such as a problem in an appearance where the waste toner collection container is exposed to outside, and a problem where the waste toner collection container is removed from the container storage portion.

In addition, there is known a configuration where an inner cover is provided on an inner side of a cover that is an exterior of the image forming apparatus. Furthermore, there is known an image forming apparatus in which the inner cover is integrally attached to an upper part of a waste toner container that stores waste toner, in order to reduce the cost by reducing the number of parts and improve the assemblability.

### SUMMARY

An image forming apparatus according to an aspect of the present disclosure includes a container storage portion, a biasing member, a lid member, a detection sensor, and an abnormality determination processing portion. The container storage portion has an opening through which a waste toner collection container is inserted and pulled out, and stores the waste toner collection container at a predetermined storage position. The waste toner collection container is provided for collecting waste toner generated inside the image forming apparatus. The biasing member biases, toward the opening, the waste toner collection container stored at the storage position in the container storage portion. The lid member constitutes a part of a housing of the image forming apparatus and is opened and closed between an opened attitude to open the opening of the container storage portion and a closed attitude to close the opening. The detection sensor is provided in the container storage portion and detects a predetermined detection object in the waste toner collection container at the storage position. The abnormality determination processing portion determines whether or not an abnormality has occurred, based on an output signal of the detection sensor, the abnormality including a state where the waste toner collection container is full of the waste toner, and a state where the waste toner collection container is not stored in the container storage portion.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A is an outer appearance view of an image forming apparatus according to an embodiment of the present disclosure, and FIG. 1B is a view showing a state where a door member has been removed from the image forming apparatus shown in FIG. 1A.

FIG. 2 is a schematic view showing an internal configuration of the image forming apparatus shown in FIGS. 1A and 1B.

FIG. 3 is a cross-sectional view schematically showing a photoconductor drum, a developing device and a cleaning unit in an image forming portion.

FIG. 4 is a schematic view showing conveyance paths of waste toner which is generated inside the image forming apparatus shown in FIGS. 1A and 1B.

FIG. 5 is an enlarged view showing a state where the door member is opened.

FIG. 6 is a perspective view of a waste toner collection container viewed from diagonally above.

FIG. 7A is a view showing a state of light between a light emitter and a light receptor in a state where the waste toner collection container is not full of waste toner, and FIG. 7B is a view showing a state of light between the light emitter and the light receptor in a state where the waste toner collection container is full of waste toner.

FIG. 8A is a graph showing a signal level of an output signal of the light receptor in a state where the waste toner collection container is not present between the light emitter and the light receptor. FIG. 8B is a graph showing a signal level of the output signal in a state where the waste toner collection container that is not full of waste toner is present between the light emitter and the light receptor. FIG. 8C is a graph showing a signal level of the output signal in a state where the waste toner collection container that is full of waste toner is present between the light emitter and the light receptor.

FIG. 9 is a view of a state where a shutter member is positioned at a first position, viewed from a container storage portion that is below the shutter member.

FIG. 10 is a view of a state where the shutter member is positioned at a second position, viewed from the container storage portion that is below the shutter member.

FIG. 11 is a view showing a state where the waste toner collection container is temporarily held at a storage position in a state where the door member is in an opened attitude.

FIG. 12 is a view showing a state where the waste toner collection container is locked to the storage position in a state where the door member is in a closed attitude.

FIG. 13 is a view showing an inner surface of the door member in the opened attitude.

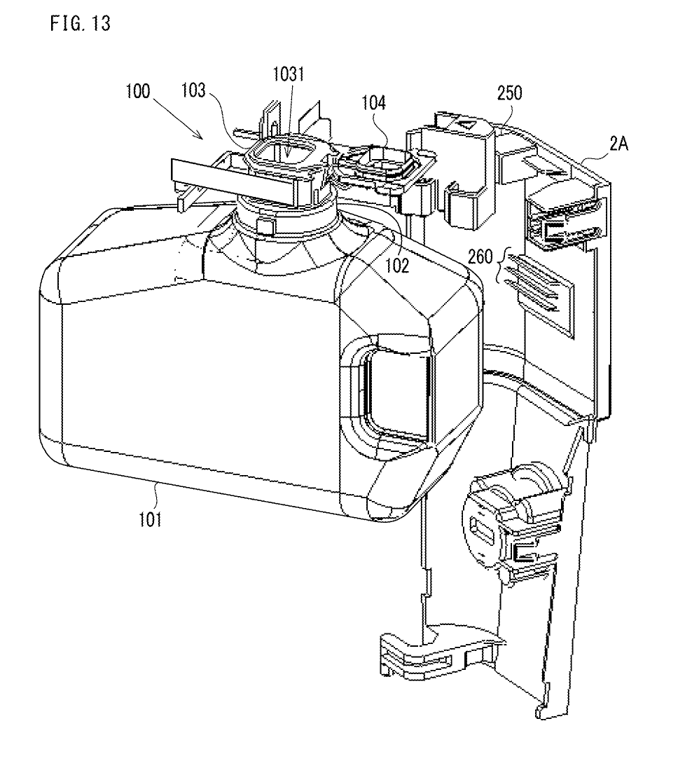

FIG. 14 is a control block diagram pertaining to the waste toner collection container of the image forming apparatus.

### DETAILED DESCRIPTION

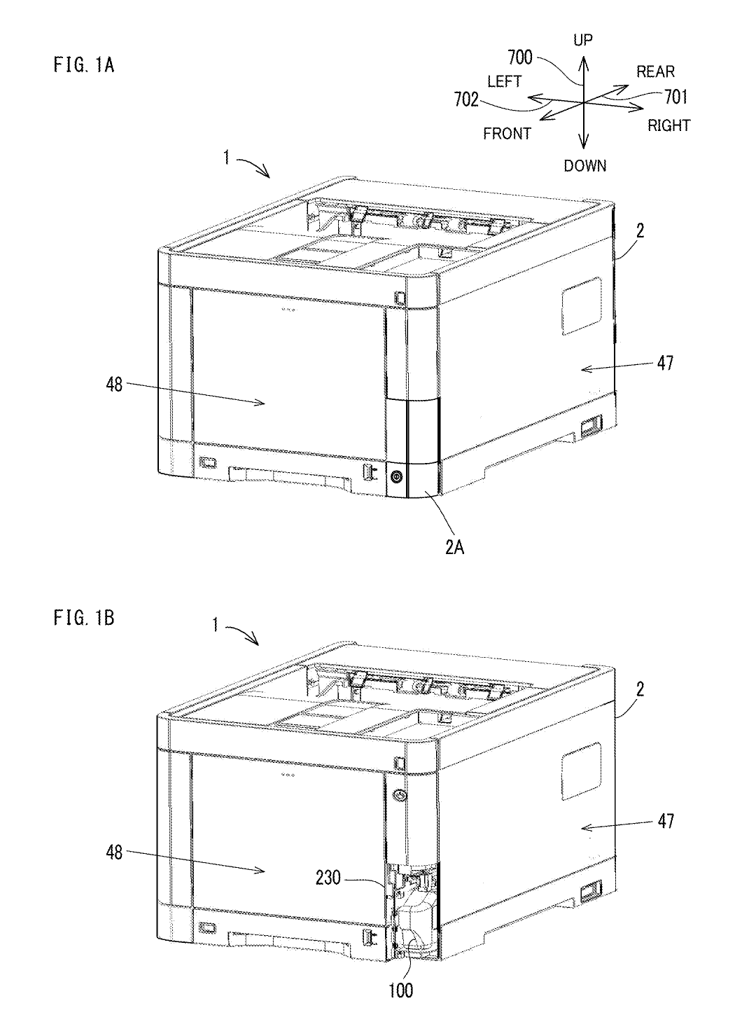

FIG. 1A is an outer appearance perspective view showing the configuration of an image forming apparatus 1 which represents an embodiment of the image forming apparatus of the present disclosure. In the following description, an up-down direction 700, a front-rear direction 701, and a left-right direction 702 may be used for reference, wherein the up-down direction 700, front-rear direction 701, and left-right direction 702 are defined as shown in FIG. 1A based on the state (the state shown in FIG. 1A) where the image forming apparatus 1 is installed in a usable manner.

As shown in FIG. 1A, the image forming apparatus 1 is a printer. The image forming apparatus 1 prints an image of input image data to a print sheet by using a print material such as toner.

The image forming apparatus 1 prints an image to a print sheet based on image data input from an external source via a network communication portion (not shown). As shown in FIG. 1A, the image forming apparatus 1 includes a housing 2 that includes a cover of an outer frame, and an inner frame.

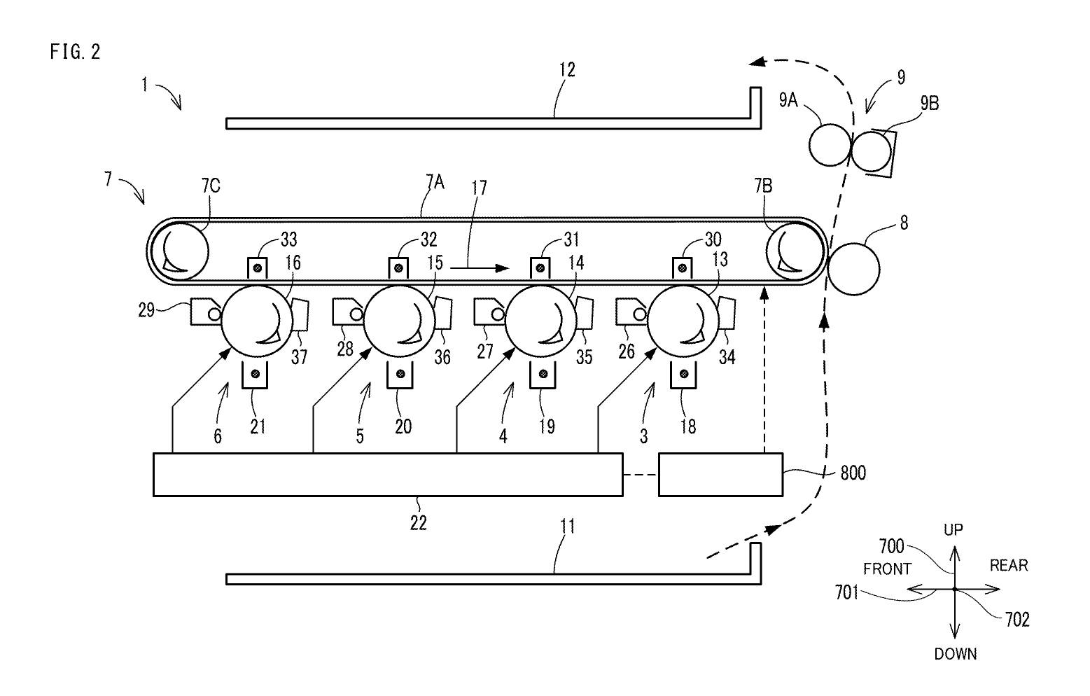

As shown in FIG. 2, the image forming apparatus 1 is a so-called tandem color image forming apparatus and includes image forming portions 3-6, an intermediate transfer unit 7, a secondary transfer device 8, a fixing device 9, an exposure device 22, a control portion 800, a sheet feed portion 11, and a sheet discharge portion 12.

The image forming portions 3-6 are disposed in alignment along the front-rear direction 701. The image forming portions 3-6 form toner images of different colors. The image forming portion 3 forms a toner image by black toner. The image forming portion 4 forms a toner image by yellow toner. The image forming portion 5 forms a toner image by cyan toner. The image forming portion 6 forms a toner image by magenta toner.

The image forming portions 3-6 include photoconductor drums 13-16, charging devices 18-21, developing devices 26-29, primary transfer devices 30-33, and cleaning units 34-37, respectively. The intermediate transfer unit 7 includes an intermediate transfer belt 7A, a driving roller 7B, and a driven roller 7C. Supported by the driving roller 7B and the driven roller 7C so as to be rotatably driven, the intermediate transfer belt 7A can move (run) in the state where its surface is in contact with the surfaces of the photoconductor drums 13-16. When the intermediate transfer belt 7A passes through between the photoconductor drums 13-16 and the primary transfer devices 30-33, the toner images are transferred in sequence from the photoconductor drums 13-16 to a surface of the intermediate transfer belt 7A in such a way as to be overlaid with each other.

The secondary transfer device 8 transfers the toner image transferred on the intermediate transfer belt 7A, to a print sheet that is conveyed from the sheet feed portion 11. The print sheet with the toner image transferred thereon is conveyed to the fixing device 9. The fixing device 9 includes a heating roller 9A and a pressure roller 9B.

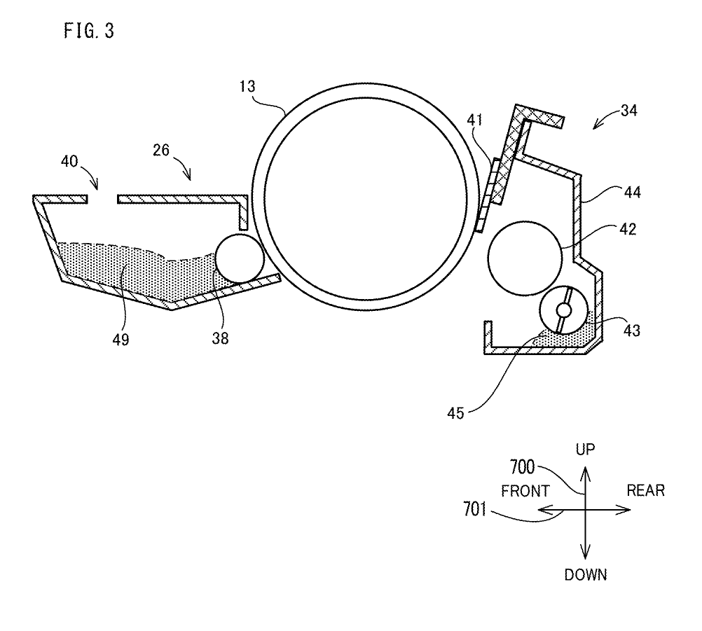

FIG. 3 is a cross-sectional view schematically showing a photoconductor drum 13, a developing device 26, and a cleaning unit 34 in an image forming portion 3. It is noted that the image forming portions 4-6 have the same configuration as the image forming portion 3. As shown in FIG. 3, the image forming portion 3 includes the developing device 26, the photoconductor drum 13, and the cleaning unit 34.

The developing device 26 includes a magnet roller 38 for developing. A bias having the same polarity as the charging polarity of the photoconductor drum 13 is applied to the magnet roller 38. Toner 49 as the developer is electrically charged by the magnet roller 38, and flown onto an electrostatic latent image on the surface of the photoconductor drum 13 so as to develop the electrostatic latent image. The toner 49 is supplied from a toner container (not shown) via a toner supply port 40.

The cleaning unit 34 includes a cleaning blade 41, a cleaning roller 42, a first screw member 43, and a toner box 44. The cleaning roller 42 and the cleaning blade 41 have approximately the same length as the photoconductor drum 13 in the axial direction, and are configured to be in contact with the photoconductor drum 13 and remove the residual waste toner from the surface of the photoconductor drum 13. The removed waste toner is taken into the toner box 44 by the action of gravity or by the rotation of the cleaning roller 42.

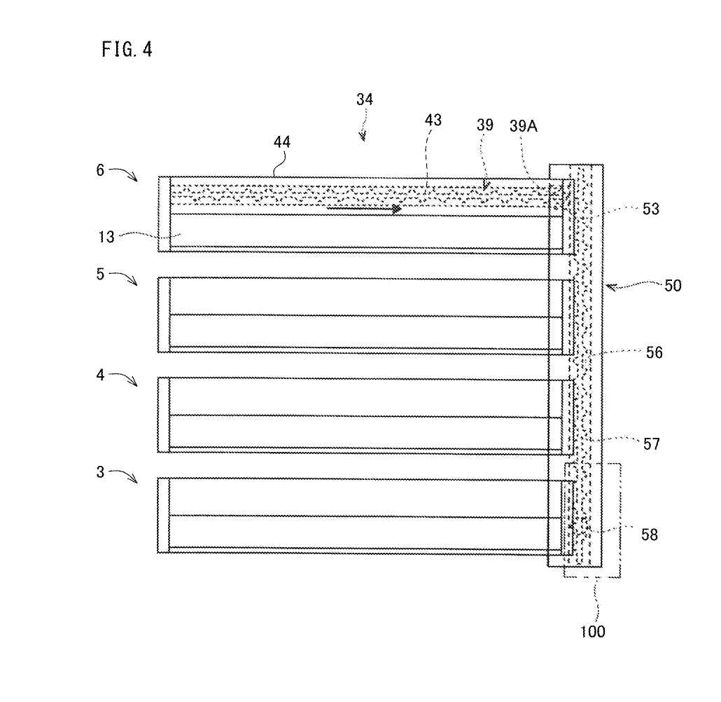

As shown in FIG. 4, waste toner 45 taken into the toner box 44 is conveyed by the first screw member 43 toward an opening portion 39A of a first conveyance path 39 formed in the toner box 44.

The image forming apparatus 1 includes a waste toner conveying device 50 for conveying the waste toner that has been conveyed by the cleaning units 34-37, to a waste toner collection container 100. The waste toner conveying device 50 is configured to connect with the cleaning units 34-37 of the image forming portions 3-6.

As shown in FIG. 4, the waste toner conveying device 50 includes a second conveyance path 56 which extends along a right-side wall 47 (see FIG. 1A). The second conveyance path 56 includes a toner introducing port 53 which introduces the waste toner from the opening portion 39A of the first conveyance path 39 formed in the toner box 44. In the second conveyance path 56, a second screw member 57 having the same configuration as the first screw member 43 is disposed. Opposite ends of the second screw member 57 in the axial direction are rotatably supported by inner walls of the second conveyance path 56, and the second screw member 57 is rotationally driven by a driving motor (not shown). In addition, a waste toner discharge port 58 is formed at a downstream-side end of the second conveyance path 56 such that the waste toner is discharged from the waste toner discharge port 58 into the waste toner collection container 100.

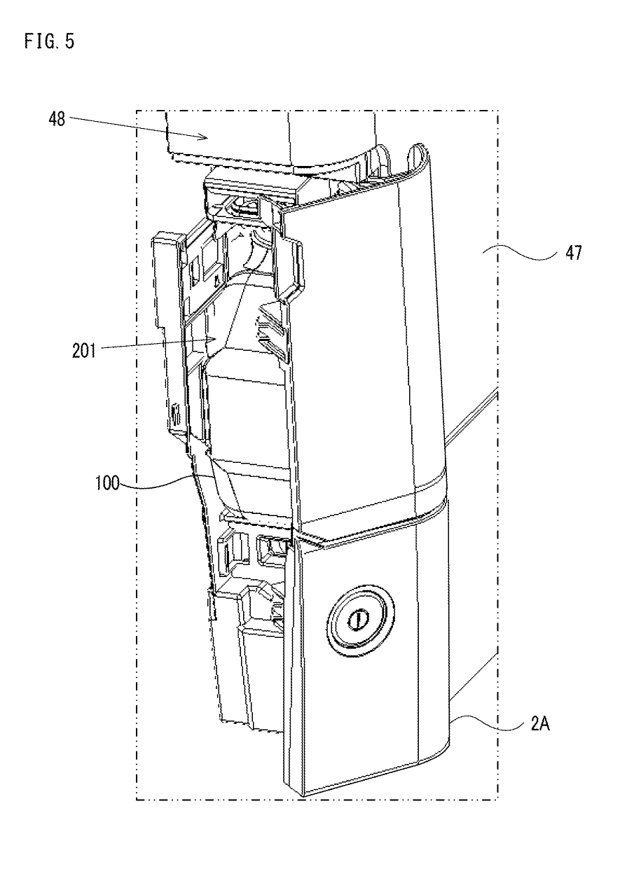

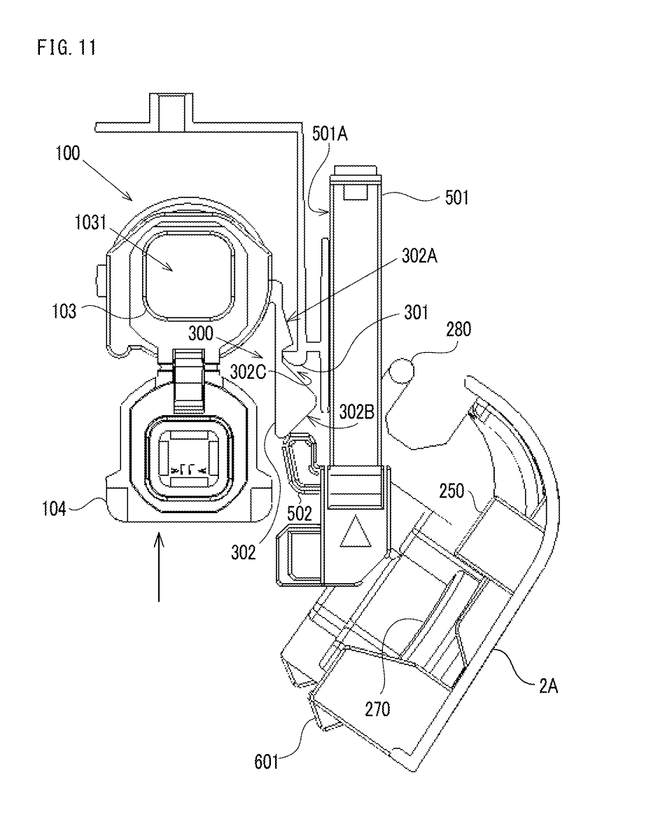

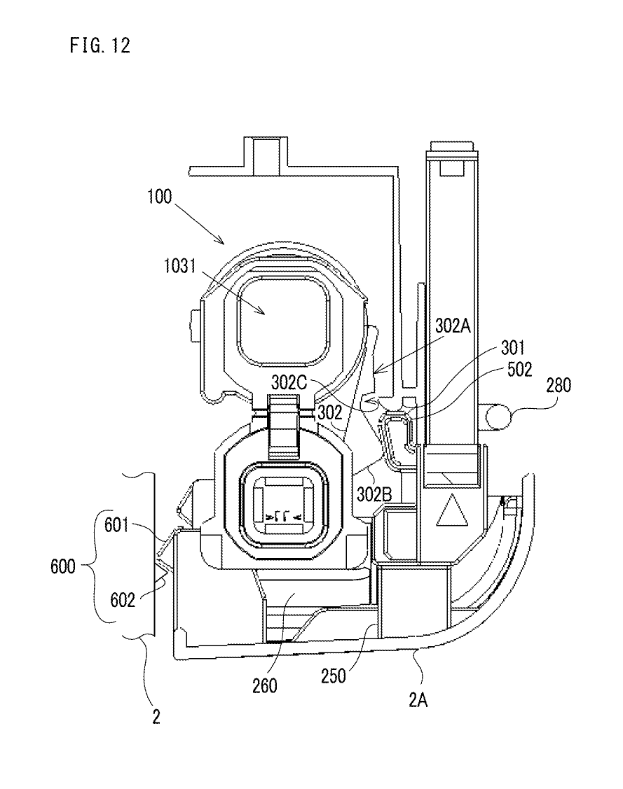

As shown in FIG. 1A, a door member 2A is provided at a predetermined location of the housing 2 of the image forming apparatus 1. In the present embodiment, the door member 2A is provided at a lower right corner of a front surface 48. The door member 2A constitutes a part of the housing 2 of the image forming apparatus 1. The door member 2A is an example of the lid member of the present disclosure. As shown in FIG. 5, the door member 2A is pivotally supported in an openable/closable manner by a pivoting shaft 280 that extends in the up-down direction 700 of the image forming apparatus 1 (see FIG. 11, FIG. 12). The door member 2A can be opened and closed between an opened attitude and a closed attitude, wherein when the door member 2A is in the opened attitude, a container storage portion 201 is exposed to the outside (see FIG. 5), and when the door member 2A is in the closed attitude, the container storage portion 201 is closed (see FIG. 1A). When the door member 2A is in the opened attitude, an opening 230 of the container storage portion 201 emerges in the housing 2 of the image forming apparatus 1 (see FIG. 1B). The waste toner collection container 100 is inserted into and pulled out from the container storage portion 201 through the opening 230. The container storage portion 201 stores the waste toner collection container 100 at a predetermined storage position. In the case where the waste toner collection container 100 is stored in the container storage portion 201, the waste toner collection container 100 can be removed from the container storage portion 201 when the door member 2A is in the opened attitude. It is noted that FIG. 1B shows a state where the door member 2A has been removed from the housing 2 of the image forming apparatus 1.

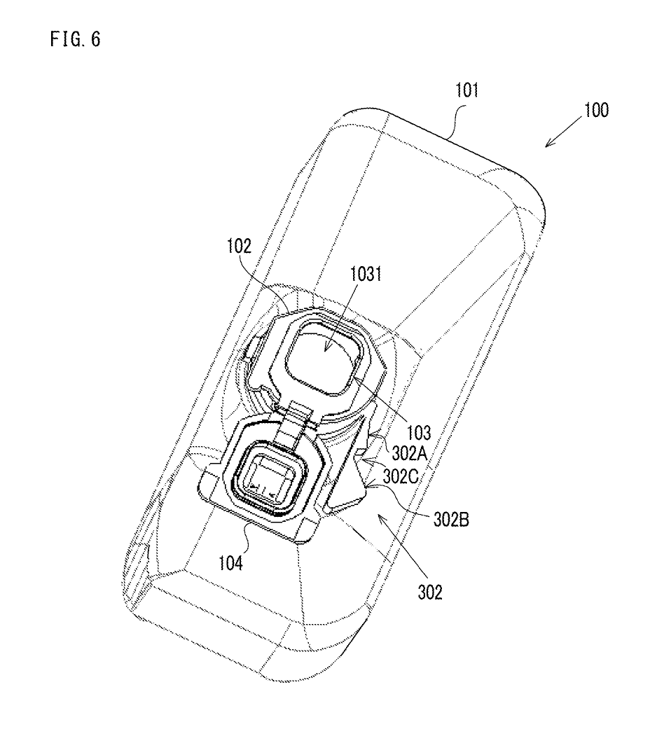

As shown in FIG. 6, the waste toner collection container 100 includes a body portion 101 and a neck portion 102. The body portion 101 reserves the waste toner that is discharged from the waste toner discharge port 58 of the second conveyance path 56. The body portion 101 corresponds to the waste toner reserving portion of the present disclosure. In the present embodiment, the body portion 101 is formed in a rectangular parallelpiped shape. However, the body portion 101 is not limited to this shape. The neck portion 102 is an upper part of the waste toner collection container 100. The neck portion 102 is communicated with the body portion 101. The neck portion 102 is smaller in cross-sectional area than the body portion 101 and extends upward from the top of the body portion 101. An upper tip portion of the neck portion 102 is a waste toner reception port 103. The waste toner reception port 103 has an opening 1031 through which the waste toner discharged from the waste toner discharge port 58 of the second conveyance path 56 is received. The neck portion 102 is made of a light-attenuating material. In the present embodiment, the neck portion 102 is made of a translucent material. It is noted that the body portion 101 may also be made of a translucent material. In addition, a cap 104 for closing the waste toner reception port 103 is provided at the neck portion 102 in an openable/closable manner. The waste toner collection container 100 is stored in the container storage portion 201 in the state where the cap 104 is opened and the waste toner reception port 103 is opened. In addition, when the waste toner collection container 100 becomes full of waste toner and pulled out from the container storage portion 201 for abandonment, the waste toner reception port 103 is closed by the cap 104.

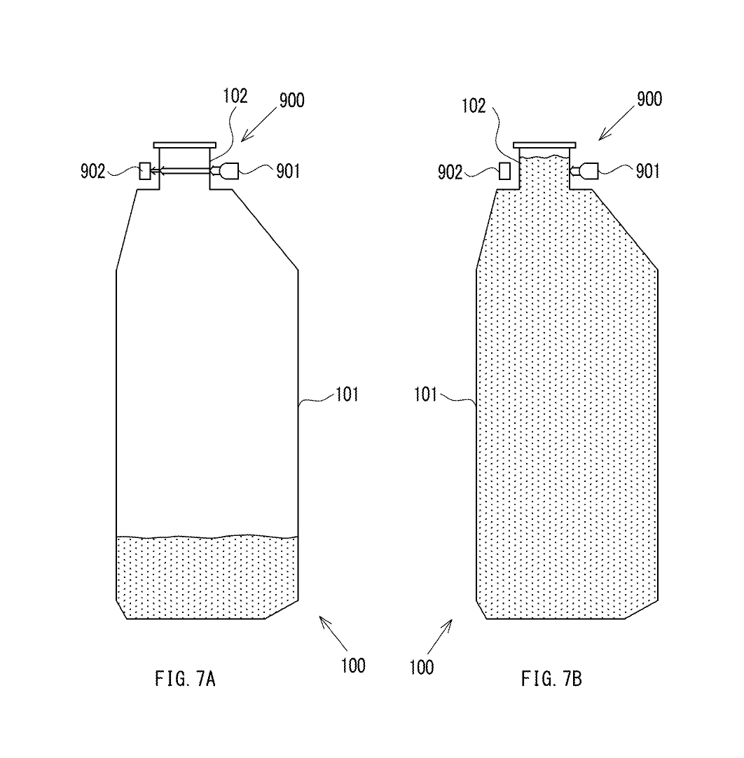

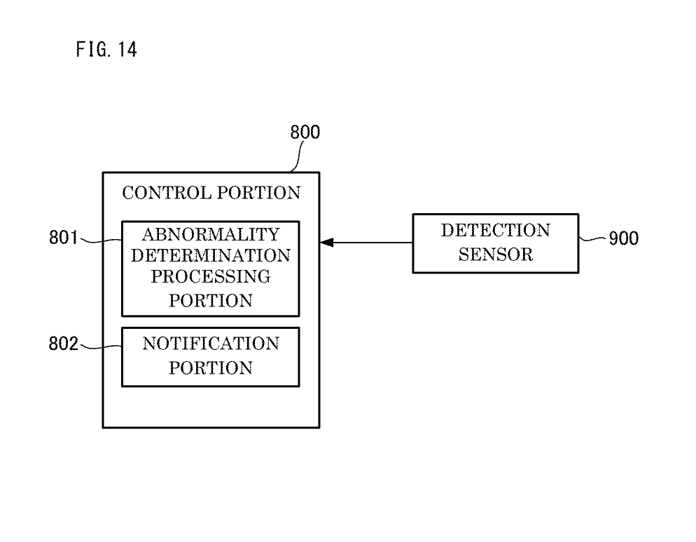

As shown in FIG. 7A, the container storage portion 201 is provided with a detection sensor 900. Specifically, the detection sensor 900 is disposed around the neck portion 102 of the waste toner collection container 100 stored in the container storage portion 201. In the present embodiment, the detection sensor 900 includes a light emitter 901 and a light receptor 902. The light emitter 901 and the light receptor 902 are disposed to face each other across the neck portion 102 of the waste toner collection container 100. That is, the light emitter 901 is disposed on one side of the neck portion 102, and the light receptor 902 is disposed on the other opposite side of the neck portion 102. The detection sensor 900 is used to detect a detection object as described below. Specifically, an output signal output from the light receptor 902 of the detection sensor 900 is used to determine whether or not the waste toner collection container 100 is present in the container storage portion 201 (determining whether the door member 2A is opened or closed), and whether or not the waste toner collection container 100 is full of waste toner. These determinations are performed by the control portion 800 as described below (see FIG. 2, FIG. 14). The determinations performed by the control portion 800 are described below.

As shown in FIG. 11, the image forming apparatus 1 includes a temporary holding mechanism 300. When the user inserts the waste toner collection container 100 into the container storage portion 201 in the state where the door member 2A is in the opened attitude (see FIG. 5), the temporary holding mechanism 300 temporarily holds the waste toner collection container 100 at the predetermined storage position. The predetermined storage position is such a position at which the waste toner collection container 100 can receive, from the waste toner reception port 103 in an appropriate manner, the waste toner that is discharged from the waste toner discharge port 58 of the second conveyance path 56.

The temporary holding mechanism 300 includes a projection 301 and an engaged portion 302. The projection 301 is provided on the housing 2 of the image forming apparatus 1 on a side (the right-side wall 47 side) with respect to the container storage portion 201 in which the waste toner collection container 100 is stored. The projection 301 projects toward the waste toner collection container 100. As shown in FIG. 6, the engaged portion 302 is provided on the container storage portion 201. The engaged portion 302 extends horizontally from the neck portion 102. The engaged portion 302 includes two crest portions 302A and 302B on a side (outer side) opposite to the waste toner collection container 100. During the process in which the waste toner collection container 100 is inserted by the user into the container storage portion 201, the projection 301 climbs over the crest portion 302A and is fitted in an indent portion 302C that is formed between the crest portions 302A and 302B. That is, the projection 301 and the engaged portion 302 are engaged with each other. This allows the waste toner collection container 100 to be temporarily held by the container storage portion 201. At this time, the waste toner collection container 100 reaches the storage position. As a result, the waste toner collection container 100 is temporarily held by the container storage portion 201 at the storage position. The temporary holding mechanism 300 is an example of the temporary holding portion of the present disclosure.

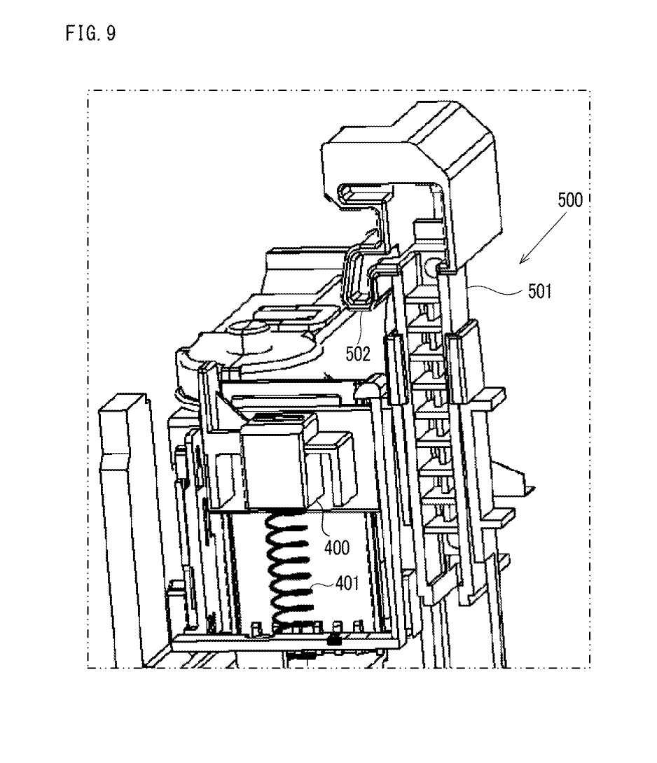

As shown in FIGS. 9-12, the image forming apparatus 1 includes a temporary-holding releasing mechanism 500. When the door member 2A is closed to the closed attitude in the state where the waste toner collection container 100 is temporarily held by the temporary holding mechanism 300, the temporary-holding releasing mechanism 500 releases the engagement of the projection 301 and the engaged portion 302 by a force provided by the attitudinal change of the door member 2A to the closed attitude. This allows the temporary holding state to be released.

Specifically, as shown in FIG. 11, the temporary-holding releasing mechanism 500 includes a moving member 501. The moving member 501 can move in parallel to the insertion/pulling-out direction of the waste toner collection container 100 with respect to the container storage portion 201. The moving member 501 is configured to move between a protruding position and a retreated position (see FIG. 12), wherein at the protruding position, the moving member 501 is protruding by a certain distance from the container storage portion 201 toward the front side of the image forming apparatus 1 (see FIG. 11), and at the retreated position, the moving member 501 is retreated in the container storage portion 201 (see FIG. 12). The moving member 501 is biased by a biasing member (not shown) such as a coil spring in a direction toward the protruding position from the retreated position. When the door member 2A is closed toward the closed attitude, a pushing portion 250 provided on an inner surface of the door member 2A abuts on the moving member 501. When the door member 2A is further closed to the closed attitude, the pushing portion 250 pushes the moving member 501 into the retreated position, resisting against the biasing force of the biasing member. In addition, when the door member 2A is opened from the closed attitude to the opened attitude, the moving member 501 moves from the retreated position (see FIG. 12) to the protruding position (see FIG. 11) by the biasing force of the biasing member.

On a side surface 501A of the moving member 501 on the container storage portion 201 side, a protruding portion 502 protruding toward the container storage portion 201 is provided. When the door member 2A is closed to the closed attitude, the protruding portion 502 pushes the crest portion 302B of the engaged portion 302 provided on the waste toner collection container 100, toward a direction opposite to the projection 301, as shown in FIG. 12. This allows the projection 301 to be distanced away from the indent portion 302C of the engaged portion 302, thereby the engagement between the projection 301 and the engaged portion 302 is released. That is, the temporary holding state of the temporary holding mechanism 300 is released. The temporary-holding releasing mechanism 500 is an example of the temporary-holding releasing portion of the present disclosure.

As shown in FIG. 12, the image forming apparatus 1 includes a lock mechanism 600. The lock mechanism 600 includes an engaging portion 601 and an engaged portion 602. In the present embodiment, the engaging portion 601 and the engaged portion 602 are formed in a mountain shape (triangular shape). The engaging portion 601 is provided on the door member 2A, and the engaged portion 602 is provided on the housing 2 of the image forming apparatus 1. As shown in FIG. 12, when the user performs an operation of closing the door member 2A, the operational force causes the engaging portion 601 to climb over the mountain of the engaged portion 602. This allows the engaging portion 601 to be engaged with an inner part of the engaged portion 602, and the door member 2A is locked to the closed attitude.

An abutting portion 260 is provided on an inner surface of the door member 2A. The abutting portion 260 abuts on a predetermined part of the body portion 101 of the waste toner collection container 100 when the door member 2A is closed to the closed attitude. This allows the waste toner collection container 100 to be held at the storage position.

As described above, when the door member 2A is closed to the closed attitude, the temporary holding of the temporary holding mechanism 300 is released. Furthermore, the door member 2A is locked to the closed attitude by the lock mechanism 600 and the waste toner collection container 100 is held at the storage position.

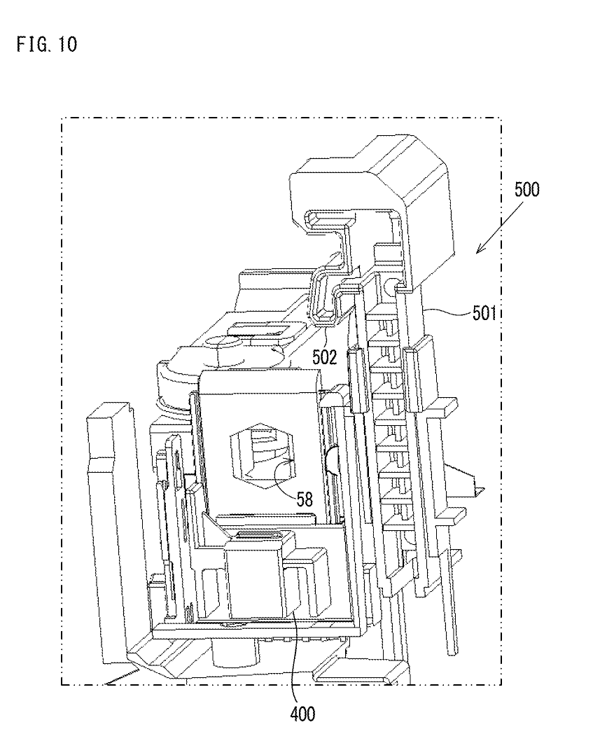

The image forming apparatus 1 includes a shutter member 400. The shutter member 400 opens and closes the waste toner discharge port 58 of the second conveyance path 56. The shutter member 400 can move in parallel to the insertion/pulling-out direction of the waste toner collection container 100 with respect to the container storage portion 201. The shutter member 400 closes the waste toner discharge port 58 of the second conveyance path 56 when it is at the most front side of the apparatus within the movement range thereof (see FIG. 9). The position of the shutter member 400 at this time is referred to as a first position (the position shown in FIG. 9). In addition, the shutter member 400 opens the waste toner discharge port 58 of the second conveyance path 56 when it is at the most depth side of the apparatus within the movement range thereof (see FIG. 10). The position of the shutter member 400 at this time is referred to as a second position (the position shown in FIG. 10). When the shutter member 400 is at the second position, the waste toner collection container 100 reaches the storage position at which the waste toner collection container 100 is temporarily held by the temporary holding mechanism 300. The second conveyance path 56 corresponds to the waste toner conveyance path of the present disclosure.

The shutter member 400 is biased by a coil spring 401 in a direction toward the first position from the second position. This allows the shutter member 400 to move when the waste toner collection container 100 is inserted into or pulled out from the container storage portion 201. That is, during the process where the user is inserting the waste toner collection container 100 into the container storage portion 201, the shutter member 400 and the waste toner collection container 100 are pushed toward the second position by the force of inserting the waste toner collection container 100, resisting against the biasing force of the coil spring 401. When the waste toner collection container 100 reaches the storage position, the shutter member 400 reaches the second position, and the waste toner discharge port 58 is opened. This allows the waste toner discharge port 58 to be communicated with the waste toner reception port 103 of the waste toner collection container 100. At this time, the waste toner collection container 100 is, in the state of being biased by the coil spring 401 toward an opening 203 that is on the outer side of the container storage portion 201, held in the container storage portion 201 by the temporary holding mechanism 300. The coil spring 401 is an example of the biasing member of the present disclosure.

On the other hand, when the door member 2A is opened, the following operations are performed. As described above, when the door member 2A is closed, the temporary holding of the temporary holding mechanism 300 is released. When, in this state, the door member 2A is opened, the waste toner collection container 100 vigorously springs out of the container storage portion 201 by the biasing force of the coil spring 401, with the projection 301 not being fitted in the indent portion 302C between the crest portions 302A and 302B. At this time, the waste toner collection container 100 is not present between the light emitter 901 and the light receptor 902. Here, the second position corresponds to the communicating position of the present disclosure. In addition, the first position corresponds to the blocking position of the present disclosure. In this way, with an insertion of the waste toner collection container 100 into the storage position and with a movement of the waste toner collection container 100 from the storage position, the shutter member 400 is moved between the second position (the communicating position) and the first position (the blocking position), wherein when the shutter member 400 is at the second position, the second conveyance path 56 is communicated with the inside of the waste toner collection container 100, and when the shutter member 400 is at the first position, the communication between the second conveyance path 56 and the inside of the waste toner collection container 100 is blocked.

As shown in FIG. 14, the image forming apparatus 1 includes the control portion 800. The control portion 800 includes CPU, ROM, and RAM. The detection sensor 900 is electrically connected to the control portion 800. The control portion 800 realizes an abnormality determination processing portion 801 and a notification portion 802 by executing programs, using the CPU. It is noted that, as another embodiment, a part of or a plurality of functions of the control portion 800 may be provided as electronic circuit(s).

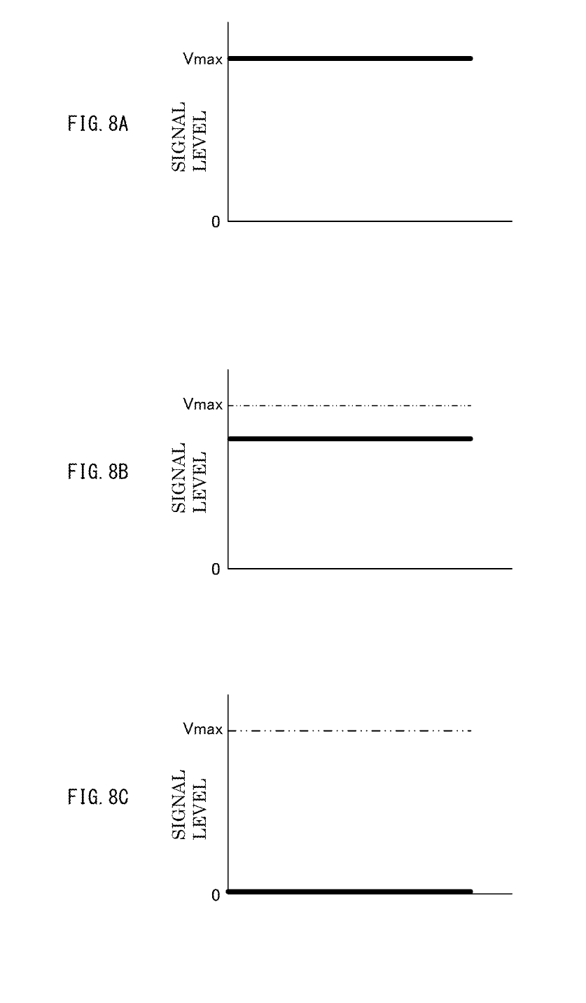

When the waste toner collection container 100 is not stored in the container storage portion 201, nothing that would interrupt the light output from the light emitter 901 exists between the light emitter 901 and the light receptor 902. In that case, the light output from the light emitter 901 is received by the light receptor 902 without having been substantially attenuated. Suppose that the signal level of the output signal of the light receptor 902 at this time is Vmax (see FIG. 8A).

As described above, at least the neck portion 102 of the waste toner collection container 100 is made of a translucent material. As a result, when the waste toner collection container 100 is stored in the container storage portion 201, the light output from the light emitter 901 is attenuated by the neck portion 102 to some extent (see FIG. 7A). As a result, the light output from the light emitter 901 and attenuated to some extent is received by the light receptor 902. At this time, as shown in FIG. 8B, the signal level of the output signal of the light receptor 902 is, by a certain amount, lower than the signal level in the case where the waste toner collection container 100 is not stored in the container storage portion 201 (see FIG. 8A).

When the waste toner accumulated in the waste toner collection container 100 stored in the container storage portion 201 reaches a position between the light emitter 901 and the light receptor 902, the light output from the light emitter 901 is almost completely blocked by the waste toner (see FIG. 7B). As a result, the light output from the light emitter 901 is not received by the light receptor 902. The signal level of the output signal of the light receptor 902 at this time is, as shown in FIG. 8C, substantially 0. The neck portion 102 of the waste toner collection container 100 and waste toner existing in the proximity of the neck portion 102 are an example of the predetermined detection object of the present disclosure.

Using the above-described points, the abnormality determination processing portion 801 determines whether or not an abnormality has occurred, based on the output signal of the light receptor 902, wherein the abnormality includes a state where the waste toner collection container 100 is full of waste toner, and a state where the waste toner collection container 100 is not stored in the container storage portion 201. In the present embodiment, the abnormality determination processing portion 801 determines, based on the signal level of the signal output from the light receptor 902, whether or not the waste toner collection container 100 is full of waste toner, and whether or not the waste toner collection container 100 is stored in the container storage portion 201.

It is determined which of the following three states the waste toner collection container 100 is currently in. One of the states is a first state where the waste toner collection container 100 is not stored in the container storage portion 201. Another one of the states is a second state where the waste toner collection container 100 is stored in the container storage portion 201 and is not full of waste toner. The last one of the states is a third state where the waste toner collection container 100 is stored in the container storage portion 201 and is full of waste toner.

The abnormality determination processing portion 801 determines the current state of the waste toner collection container 100 based on the output signal of the detection sensor 900. The ROM of the control portion 800 stores, in advance, determination values that are used by the abnormality determination processing portion 801. The determination values are divided into predetermined ranges in correspondence with the first to third states. The abnormality determination processing portion 801 determines which state among the first to third states the waste toner collection container 100 is in, based on the range of the determination values to which the signal level of the output signal of the detection sensor 900 belongs. Upon determining that the waste toner collection container 100 is in the first state or the third state, the abnormality determination processing portion 801 notifies the notification portion 802 of it.

Here, in the present embodiment, as described above, when the door member 2A is opened, the waste toner collection container 100 vigorously springs out of the container storage portion 201 by the biasing force of the coil spring 401. At this time, the waste toner collection container 100 is not present between the light emitter 901 and the light receptor 902. That is, when the door member 2A is opened, the waste toner collection container 100 is not stored in the container storage portion 201. In view of this, in the present embodiment, upon determining that the waste toner collection container 100 is in the first state of not being stored in the container storage portion 201, the abnormality determination processing portion 801 notifies the notification portion 802 that the door member 2A is opened.

Upon receiving the notification of the first state from the abnormality determination processing portion 801, the notification portion 802 notifies that the door member 2A is opened, via a touch panel or an audio output portion that are not shown. In addition, upon receiving the notification of the third state from the abnormality determination processing portion 801, the notification portion 802 notifies that the waste toner collection container 100 is full of waste toner, via the touch panel or the audio output portion.

As described above, the coil spring 401 biases the waste toner collection container 100 that is stored at the storage position in the container storage portion 201, toward the opening 230 side. As a result, when the door member 2A is opened, the waste toner collection container 100 is pushed out of the container storage portion 201 and becomes undetectable by the detection sensor 900. That is, it is possible to detect that the door member 2A is opened when the detection sensor 900 does not detect the presence of the waste toner collection container 100. As a result, according to the present embodiment, only one detection sensor 900 can be used to detect an abnormal state: a state where the waste toner collection container 100 is full of waste toner; or a state where the door member 2A is opened. With this configuration, there is no need to provide, individually, a detection sensor for detecting whether or not the waste toner collection container 100 is full of waste toner, and a detection sensor for detecting whether or not the door member 2A is opened. As a result, the number of detection sensors can be reduced, thus the number of parts and the cost can be reduced.

In the embodiment, the temporary holding mechanism 300 is provided in the image forming apparatus 1 in order to facilitate the attachment of the waste toner collection container 100 to the container storage portion 201. However, the waste toner collection container 100 is held at the storage position in the container storage portion 201 when the user pushes the waste toner collection container 100 into the container storage portion 201 and locks the door member 2A when he/she moves the door member 2A to the closed attitude. As a result, the temporary holding mechanism 300 is not necessarily required.

In the embodiment, notifications are made individually with a ditiction between a state where the waste toner collection container 100 is full of waste toner and a state where the door member 2A is opened. However, in the case where there is no need to distinguish between these states, it is possible to adopt a configuration where these states are collectively notified as an abnormal state when the signal level of an output signal of the light receptor 902 does not belong to a predetermined range of values which is set with reference to Vmax.

In the embodiment, as an example of the lid member of the present disclosure, the door member 2A is adopted, wherein the door member 2A is pivotally supported in an openable/closable manner by the pivoting shaft 280 that extends in the up-down direction 700 of the image forming apparatus 1 (see FIG. 11, FIG. 12). However, the lid member of the present disclosure is not limited to the door member 2A. For example, it is possible to adopt a door member whose upper part or lower part is pivotally supported in an openable/closable manner by a pivoting shaft that extends in the left-right direction 702 of the image forming apparatus 1. In addition, it is possible to adopt a member that opens the container storage portion 201 when it is located away from the housing 2 by being parallelly moved from the state where it is attached to the image forming apparatus 1.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a container storage portion having an opening through which a waste toner collection container is inserted and pulled out, and configured to store the waste toner collection container at a predetermined storage position, the waste toner collection container being for collecting waste toner generated inside the image forming apparatus;
a biasing member configured to bias, toward the opening, the waste toner collection container stored at the storage position in the container storage portion;
a lid member constituting a part of a housing of the image forming apparatus and configured to be opened and closed between an opened attitude to open the opening of the container storage portion and a closed attitude to close the opening;
a detection sensor provided in the container storage portion and configured to detect a predetermined detection object in the waste toner collection container at the storage position; and
an abnormality determination processing portion configured to determine whether or not an abnormality has occurred, based on an output signal of the detection sensor, the abnormality including a state where the waste toner collection container is full of the waste toner, and a state where the waste toner collection container is not stored in the container storage portion.

2. The image forming apparatus according to claim 1, further comprising
a temporary holding portion configured to temporarily hold the waste toner collection container at the storage position in the container storage portion in a state where the lid member is in the opened attitude;
a temporary-holding releasing portion configured to, when the lid member is moved to the closed attitude in a state where the waste toner collection container is temporarily held at the storage position in the container storage portion by the temporary holding portion, release the temporary holding of the temporary holding portion; and
a lock mechanism provided on the lid member and configured to, when the lid member is moved to the closed attitude, hold the waste toner collection container at the storage position in the container storage portion, and lock the lid member to the closed attitude.

3. The image forming apparatus according to claim 2, wherein
the temporary holding portion includes a projection and an engaged portion, wherein the projection is provided on the housing of the image forming apparatus, the engaged portion is provided on the waste toner collection container, and the temporary holding portion temporarily holds the waste toner collection container at the storage position in the container storage portion by an engagement between the projection and the engaged portion.

4. The image forming apparatus according to claim 3, wherein
the temporary-holding releasing portion releases a temporary holding of the temporary holding portion by releasing the engagement between the projection and the engaged portion by a force provided by an attitudinal change of the lid member to the closed attitude.

5. The image forming apparatus according to claim 2, further comprising
an abutting portion provided on an inner surface of the lid member and configured to abut on the waste toner collection container when the lid member is in the closed attitude, and hold the waste toner collection container at the storage position resisting against a biasing force of the biasing member.

6. The image forming apparatus according to claim 1, further comprising
a shutter member configured to allow an inside of the waste toner collection container stored in the container storage portion to communicate with a waste toner conveyance path in which the waste toner generated inside the image forming apparatus is conveyed to the container storage portion, and to block a communication between the inside of the waste toner collection container and the waste toner conveyance path, wherein
the shutter member is configured to, with an insertion of the waste toner collection container to the storage position and with a movement of the waste toner collection container from the storage position toward the opening, be moved between a communicating position and a blocking position, wherein when the shutter member is at the communicating position, the waste toner conveyance path is communicated with the inside of the waste toner collection container, and when the shutter member is at the blocking position, the communication between the waste toner conveyance path and the inside of the waste toner collection container is blocked.

7. The image forming apparatus according to claim 1, wherein
the waste toner collection container includes a waste toner reserving portion and a neck portion, wherein the waste toner reserving portion reserves the waste toner, the neck portion is a waste toner reception port and communicated with the waste toner reserving portion, and the neck portion is smaller in cross-sectional area than the waste toner storage portion, and
the detection object is the neck portion.

8. The image forming apparatus according to claim 1, wherein
the detection sensor includes a light emitter and a light receptor that are disposed at opposite sides across the neck portion,
the neck portion is made of a material that attenuates light emitted from the light emitter, and
the abnormality determination processing portion determines either the state where the waste toner collection container is full of the waste toner or the state where the waste toner collection container is not stored in the container storage portion has occurred, based on a signal level of a signal output from the light receptor.
